(19) United States
(12) Patent Application Publication
(10) Pub. No.: US 2025/0335945 A1
(43) Pub. Date: Oct. 30, 2025

(54) METHOD, DEVICE, AND COMPUTER PROGRAM PRODUCT FOR GENERATING A REPORT

(71) Applicant: Dell Products L.P., Round Rock, TX (US)

(72) Inventors: Zijia Wang, London (GB); Zhen Jia, Shanghai (CN); Yuting Zhang, Chengdu (CN)

(21) Appl. No.: 18/672,656

(22) Filed: May 23, 2024

(30) Foreign Application Priority Data
Apr. 26, 2024 (CN) 202410517058.7

(51) Int. Cl. G06Q 30/0203; G06F 40/186; G06Q 30/0282

(52) U.S. Cl. CPC G06Q 30/0203; G06F 40/186; G06Q 30/0282

(57) ABSTRACT

The present disclosure relates to a method, a device, and a computer program product for generating a report. A method in an illustrative embodiment includes: acquiring object data associated with a user's evaluation of an object, generating first text of the object by a language model according to the object data, and generating a report according to the first text and a graph neural network, wherein the graph neural network is associated with a plurality of objects. In this way, a report on an object can be generated by a machine, which is more convenient and time-saving and improves accuracy and efficiency; and a plurality of other objects can be taken into account according to a report on object data of one object, so that a more comprehensive analysis result can be obtained.

### RELATED APPLICATION

The present application claims priority to Chinese Patent Application No. 202410517058.7, filed Apr. 26, 2024, and entitled “A Method, Device, and Computer Program Product for Generating a Report,” which is incorporated by reference herein in its entirety.

### FIELD

The present disclosure relates to the field of artificial intelligence, and more specifically, relates to a method, device, and computer program product for generating a report.

### BACKGROUND

Object data for comments, feedback or surveys on products, for example, often contain valuable information, such as reflecting users' satisfaction with or users' recommendations on current products or objects. Therefore, an analysis of object data to generate reports can help product providers understand users' needs, preferences, and expectations, thereby improving the quality, performance, and innovation of products.

A language model or natural language generation (NLG) model is a model of the probability distribution of words in a natural language, which is commonly used to process text data. This technology has resulted in remarkable achievements in various technologies, such as text summarization, machine translation, and information retrieval.

### SUMMARY

Embodiments of the present disclosure relate to a method, device, and computer program product for generating a report.

According to one aspect of the present disclosure, a method for generating a report is provided. The method includes acquiring object data associated with a user's evaluation of an object; generating first text of the object by a language model according to the object data; and generating the report according to the first text and a graph neural network, where the graph neural network is associated with a plurality of objects.

According to another aspect of the present disclosure, an electronic device is provided. The electronic device includes at least one processor and a memory, where the memory is coupled to the at least one processor and has instructions stored therein. The instructions, when executed by the at least one processor, cause the electronic device to perform actions. The actions include: acquiring object data, the object data being object data associated with a user's evaluation of an object; generating first text of the object by a language model according to the object data; and generating a report according to the first text and a graph neural network, where the graph neural network is associated with a plurality of objects.

According to still another aspect of the present disclosure, a computer program product is provided. The computer program product is tangibly stored on a non-transitory computer-readable medium and includes machine-executable instructions that, when executed by a machine, cause the machine to perform actions. The actions include: acquiring object data, the object data being object data associated with a user's evaluation of an object; generating first text of the object by a language model according to the object data; and generating a report according to the first text and a graph neural network, where the graph neural network is associated with a plurality of objects.

It should be understood that this Summary is neither intended to limit key or essential features of embodiments of the present disclosure, nor intended to limit the scope of the present disclosure. Other features of the present disclosure will become readily understood from the additional description provided herein.

### BRIEF DESCRIPTION OF THE DRAWINGS

The above and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 is a schematic diagram of an example environment in which a process for generating a report in which some embodiments of the present disclosure may be implemented;

FIG. 2 is a flow chart of a method for generating a report according to some embodiments of the present disclosure;

FIG. 3 is a flow chart of a method for generating first text according to some embodiments of the present disclosure;

FIG. 4 is a flow chart of another method for generating first text according to some embodiments of the present disclosure;

FIG. 5 is a flow chart of a method for modifying a first template according to some embodiments of the present disclosure;

FIG. 6 is a flow chart of a method for modifying a report according to some embodiments) of the present disclosure;

FIG. 7 is a schematic diagram of a process for generating a report according to embodiments of the present disclosure; and

FIG. 8 is a block diagram of a device that can implement some embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be interpreted as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same objects. Other explicit and implicit definitions may also be included below.

Relevant report generation methods usually involve extensive manual effort, in which various professional tasks such as data collection, statistics, and classification need to be performed manually to analyze object data to generate reports on objects. This manner of generating reports is time-consuming, inefficient, and error-prone, especially for large amounts of object data. Although some automated report generation methods exist, these methods can only analyze data of specific objects or generate text content related to specific objects. Also, the report content is not rich enough, and it is not possible to form comprehensive reports.

Therefore, embodiments of the present disclosure provide a solution of generating a report based on a language model. In embodiments of the present disclosure, object data associated with a user's evaluation of an object is acquired; first text of the object is generated by a language model according to the object data; and the report is generated according to the first text and a graph neural network, where the graph neural network is associated with a plurality of objects.

In this way, a report on an object can be generated using a natural language model by a machine, which is more convenient and saves time, while also improving accuracy and efficiency. Also, through embodiments of the present disclosure, a report can be generated by taking into account a plurality of other objects from object data of one object, so that a more comprehensive analysis result can be obtained.

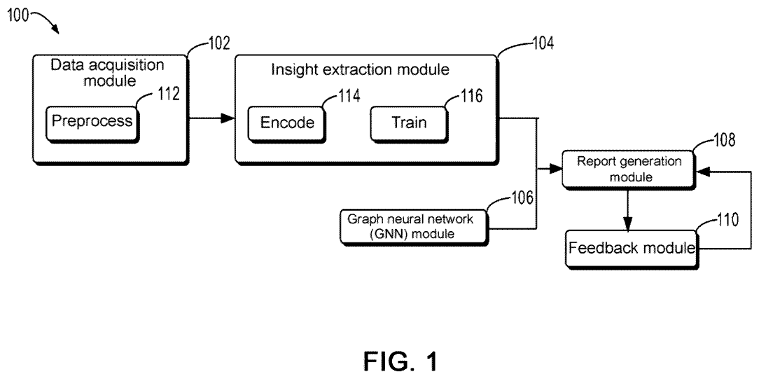

FIG. 1 is a schematic diagram of an example environment 100 in which a process for generating a report in which some embodiments of the present disclosure may be implemented. As shown in FIG. 1, the environment 100 illustratively includes a data acquisition module 102, an insight extraction module 104, a graph neural network (GNN) module 106, and a report generation module 108.

As shown in FIG. 1, the environment 100 includes a data acquisition module 102 that can preprocess object data in a preprocessing module 112. For example, the data acquisition module 102 can accept raw object data in various formats, such as text, comma-separated values (CSV), and JavaScript Object Notation (JSON), and convert the raw object data to appropriate inputs for the insight extraction module 104. For example, the object data may be associated with a user's evaluation of an object.

As shown in FIG. 1, the environment 100 includes an insight extraction module 104 that can generate an insight about the object based on the preprocessed object data. For example, the insight about the object may be text output generated by a machine based on understandings of causality, sentiment, anomalies, trends, and other patterns in the object data.

In some embodiments, the insight extraction module 104 can encode the preprocessed object data in an encoding module 114. In some embodiments, the insight extraction module 104 can be implemented as a language model, e.g., a transformer-based model. In some embodiments, the insight extraction module 104 can be trained in a training module 116 by contrastive learning to obtain a more accurate insight.

As shown in FIG. 1, the environment 100 includes a graph neural network module 106 that can preset or pretrain a graph neural network associated with a plurality of objects or a plurality of products. For example, the graph neural network can reflect relationships between the plurality of objects. Specifically, hierarchies in the graph neural network can represent a classification architecture of the objects, each node can represent an object, and edges between the nodes can represent relationships between the objects. For example, the hierarchies of the graph neural network can include smaller and smaller ranges from top to bottom.

In some embodiments, the objects may be notebook computer products, the hierarchy in the graph neural network may represent different classes or different series, e.g., business notebooks, gaming notebooks, ultrabooks, 2-in-1 notebooks, etc., the nodes in the graph neural network may represent different notebook computer products (their classes or models), and the edges between nodes represent which notebook computer products are included in a particular class or series.

In some embodiments, the objects may be electronic products, a first hierarchy in the graph neural network may represent a large class of the electronic products, such as computers, mobile phones, wearable devices, and other electronics, a second hierarchy may represent different small classes within a particular large class, and a third hierarchy may represent different product models within a particular small class. In this embodiment, the nodes may represent different electronic products, and the edges between nodes may represent relationships between different electronic products, such as belonging to same or different classes, belonging to same or different series, inclusive relation or parallel relation, or the like.

As shown in FIG. 1, the environment 100 includes a report generation module 108 that can generate a report based on the insight about the object from the insight extraction module 104 and the graph neural network from the graph neural network module 106. In some embodiments, the report generation module 108 may include a template library. For example, the report generation module 108 can select an appropriate template from the template library according to the insight about the object generated by the insight extraction module 104, and can generate a report based on the selected template, first text, and the graph neural network.

In some embodiments, the environment 100 may further include a feedback module 110 that can include a user feedback loop for generating the user's feedback about a corresponding report. In some embodiments, the user feedback loop can generate corresponding feedback according to the report from the report generation module 108. The feedback module 110 can then transmit the feedback to the report generation module 108 to modify the template or report.

It should be understood that the category and quantity of the modules, data transmission process, arrangement, implementation manner, and the like shown in FIG. 1 are merely illustrative, and the environment 100 may include different quantities of models arranged in different manners, different data transmission processes, various additional elements, and so on. It should be understood that the above models, networks, or algorithms are provided only as examples and that different models, networks, or algorithms may be used to implement various modules of the environment 100.

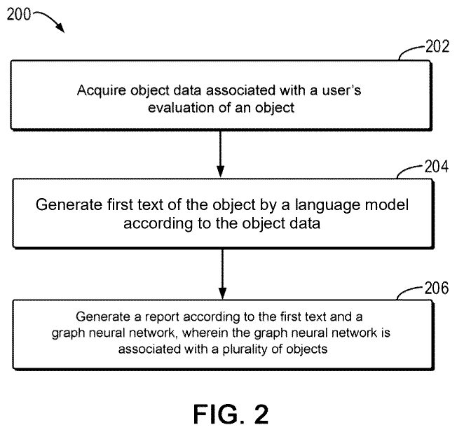

FIG. 2 is a flow chart of a method 200 for generating a report according to some embodiments of the present disclosure. To better describe the method 200, a description is made with reference to the example environment 100 described in FIG. 1.

At block 202, object data associated with a user's evaluation of an object is acquired. For example, in the environment 100 of FIG. 1, object data associated with a user's evaluation of a particular object can be acquired by the data acquisition module 102.

In some embodiments, the object data may include the user's evaluation of a particular object or product. For example, the evaluation can include a neutral evaluation, a positive evaluation, or a negative evaluation. Specifically, a neutral evaluation can be a user's recommendation of the product, a positive evaluation can be a user's praise of the product, and a negative evaluation can be a user's criticism of the product.

At block 204, first text of the object is generated by a language model according to the object data. For example, in the environment 100 of FIG. 1, the first text of the object can be generated by the insight extraction module 104 according to the object data. In some embodiments, the first text of the object may be an insight about the object, that is, text that is associated with the object and generated by the insight extraction module 104 based on the user's evaluation of the object. For example, the first text may include sentiment understandings, summarization, trend predictions, causal reasoning, and anomaly analysis of the evaluation generated by the language model,

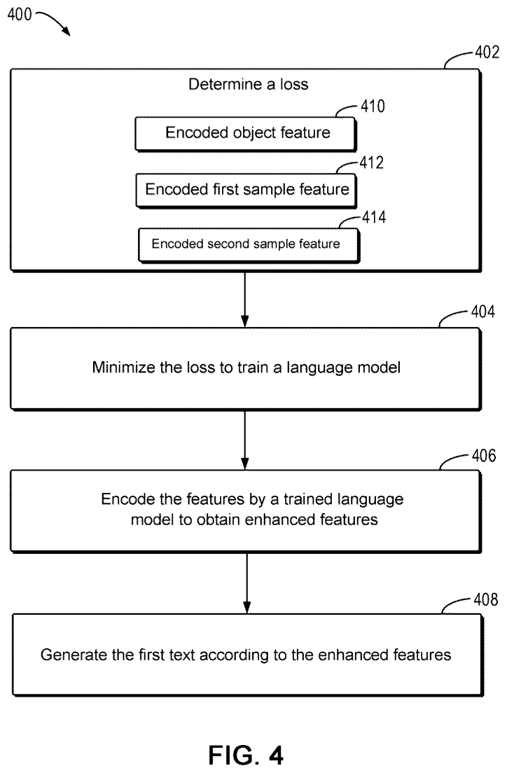

In some embodiments, the language model can be implemented as a transformer-based model. For example, the transformer-based model can extract feature vectors according to object data, encode the feature vectors, and generate the first text according to the encoded vector features. In some embodiments, the transformer-based model can be trained based on contrastive learning to improve accuracy and correlation over time. The training of the language model will be discussed below with reference to FIG. 4.

In some embodiments, the language model can be implemented as any known NLG, such as a Bidirectional Encoder Representations from Transformers (BERT) model, a Generative Pre-trained Transformer (GPT) model (e.g., GPT-2), and a T5 model, which utilizes large-scale pre-training of mass text corpora and fine-tuning of specific downstream tasks to generate fluent and coherent text. It should be understood that the above models, networks, or algorithms are provided only as examples and that different models, networks, or algorithms may be used to implement the language model.

At block 206, a report is generated according to the first text and a graph neural network, where the graph neural network is associated with a plurality of objects. For example, in the environment 100 of FIG. 1, the report can be generated by the report generation module 108 according to the first text from the insight extraction module 104 and the graph neural network from the graph neural network module 106.

In some embodiments, the graph neural network is a neural network that manipulates graph-structured data (such as social networks, knowledge graphs, and molecular graphs). In some embodiments, the graph neural network can learn node representations and edge representations by aggregating and propagating information across graphs. In some embodiments, the graph neural network can model relationships between a plurality of objects, for example, according to the classes, series, and hierarchical relationships of different objects. For example, nodes can represent different products, and edges can represent relationships between different products.

With method 200, the report on the object can be generated by a machine based on the language model without human operations, which is more convenient and time-saving and improves accuracy and efficiency. Also, since method 200 combines the first text based on the object data with the graph neural network based on the relationships between the plurality of objects, the report can be generated by taking into account a plurality of other objects from the object data of one object, so that a more comprehensive analysis result can be obtained.

In one embodiment, for example, when the object data is a user's negative evaluation of a product, in method 200, the negative evaluation can be understood and reasons for the negative evaluation can be analyzed in the first text, and whether there are similar problems in other associated products (e.g., other products in the same series or other products in the same class) is analyzed based on the first text and the graph neural network and then reflected in the report. As a result, the report generated according to the method 200 can include a more comprehensive analysis result.

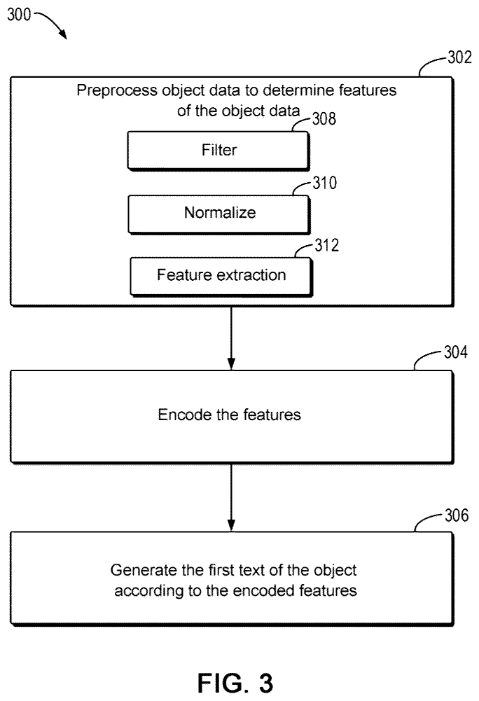

FIG. 3 is a flow chart of a method 300 for generating first text according to some embodiments of the present disclosure. To better describe the method 300, a description is made with reference to the example environment 100 described in FIG. 1.

At block 302, the object data is preprocessed to determine features of the object data. For example, in the environment 100 of FIG. 1, the data object can be preprocessed in the preprocessing module 112 of the data acquisition module 102 to determine the features of the object data. In some embodiments, the features of the object data can be feature vectors extracted from the object data. For example, the object data can be tokenized to segment text of the object data into individual tokens so that subsequent models can better understand and process text data.

In some embodiments, a BOW (Bag of Words) model can be used to extract the feature vectors from the text data. For example, the BOW model can extract words in the text to form a set of words and build a bag of words, count the number of occurrences of each word in the text to determine a term frequency, and take the words in the bag of words as the dimension and the term frequency as the value of the corresponding dimension to build the feature vectors of the text data.

In some embodiments, N-gram can be used to extract N consecutive words in the text data as features to determine the features of the text data. In some embodiments, a pre-trained word vector model can be used to map words to vectors to determine the features of the text data. In some embodiments, the features of the text data can be determined according to textual statistical features, such as a word's length, part of speech, and the like.

At block 304, the features are encoded. For example, in the environment 100 of FIG. 1, the data object can be encoded in the encoding module 114 of the insight extraction module 104 to obtain the encoded features. In some embodiments, the features of the object data can be encoded by a transformer-based model. In this embodiment, feature extraction of the text data can be performed by an embedding layer of a transformer-based model, weighted summation is performed on features at different locations by a multi-head attention mechanism to capture semantic relationships in the text, and further feature extraction and transformation will be performed on an output of the attention mechanism by a feed-forward network to encode the features.

In some embodiments, the feature vectors (e.g., text tokens) generated from the object data can be input into a language model, and then the language model encodes the input features into a rich context representation based on the feature vectors and the parameters of the language model. In some embodiments, the parameters of the language model can be trained and adjusted according to subsequently generated text, thereby improving the quality of the text.

At block 306, the first text of the object is generated according to the encoded features. For example, in the environment 100 of FIG. 1, the first text of the object can be generated by the insight extraction module 104 according to the encoded feature vectors. In some embodiments, a language model can analyze and interpret the encoded features, identify underlying patterns, relationships, and trends, and then combine domain knowledge and contexts to generate the first text. In some embodiments, a decoding mechanism may be used to progressively generate the first text.

As shown in FIG. 3, preprocessing the object data at block 302 can include: at block 308, filtering the object data; at block 310, normalizing the filtered object data; and at block 306, extracting the features of the object data according to the normalized object data.

In some embodiments, the object data can be cleaned to remove irrelevant information, correct errors, and process missing information, thereby filtering the object data. It should be understood that the object data can be cleaned by using any data cleaning function known in the art.

In some embodiments, for the text data, data cleaning can be performed by: removing special symbols, excess spaces, etc., to remove noise; unifying the coded format of the text; using spell-checking tools or algorithms to correct and convert uppercase and lowercase letters; unifying the uppercase and lowercase letters of the text and segmenting the text into words or terms as needed; and removing common words that are of little analytical significance.

In some embodiments, the filtered object data can be normalized to adjust the data to a common scale without distorting differences within the range of values. In some embodiments, the filtered text data can be represented as vectors using a vector space model (VSM), and normalization is implemented by normalizing the vectors. In some embodiments, the text data can be mapped to a hash space using locality sensitive hashing (LSH) to implement text-like clustering and normalization for normalization. In some embodiments, the subject matter of the text data can be modeled and normalized using a topic model such as a Latent Dirichlet Allocation (LDA).

In some embodiments, the object data can be normalized by a BOW model in combination with TF-IDF weight computation. For example, all words in the text are extracted to form a set of words and to build a bag of words; the number of occurrences of each word in each part of the text is counted to compute a term frequency (TF); an inverse document frequency (IDF) is computed to measure the rarity of a word in the entire text; and TF-IDF weights are computed, that is, the TF and the IDF are multiplied to obtain the normalized weight of each word. By computing the TF-IDF weights, it is possible to highlight those words that appear frequently in a particular part of the text and are relatively uncommon in the entire text set, thus better representing the features of the text.

It should be understood that the types and numbers, arrangements, implementations, and the like of the models, networks, and algorithms shown above are only illustrative, and that method 300 may include different models, networks, or algorithms, as well as various additional models, networks, or algorithms, etc.

FIG. 4 is a flow chart of another method 400 for generating first text according to some embodiments of the present disclosure. For example, the method 400 illustratively includes training the language model, and using the trained language model to generate the first text. For example, the method 400 can be performed by the insight extraction module 104 in the environment 100 in FIG. 1.

As shown in FIG. 4, at block 402, a loss is determined based on the first text, a first sample, and a second sample; in some embodiments, the first sample is generated according to the first text, and the second sample is acquired from a sample library. For example, the first text can be manually input or generated by a language model.

In some embodiments, the first sample is emotionally associated with the first text, and the second sample is not emotionally associated with the first text. In some embodiments, the first sample is semantically associated with the first text, and the second sample is not semantically associated with the first text. In some embodiments, the association of the samples with the first text is determined based on substantive meaning, for example, by taking into account irony, a word with multiple meanings, or multiple words with one meaning. In some embodiments, whether the samples are associated with the first text is determined in light of the context of the text.

For example, the first text could be a user's negative evaluation of the object, i.e., “the product is not good.” In this case, the first text may be text associated with the negative evaluation, e.g., “the product has poor a performance,” “the product is slow,” “the product takes a long time to process,” and so on. Moreover, the second sample may be a neutral evaluation of the object, such as a recommendation, or a positive evaluation, e.g., “the product has a good performance,” “the product is fast,” and so on.

In some embodiments, the loss can be determined by the following actions: at block 410, an encoded object feature is determined according to the object data; at block 412, an encoded first sample feature is determined according to the first sample; and at block 414, an encoded second sample feature is determined according to the second sample. Further, the loss is determined based on the encoded object feature, the encoded first sample feature, and the encoded second sample feature.

For example, the object data, the first sample data, and the second sample data can be preprocessed and encoded according to the various data preprocessing and encoding methods described in FIG. 3 above to determine the encoded object feature, the encoded first sample feature, and the encoded second sample feature. It should be understood that the feature vector extracted from the object data is encoded to obtain the encoded object feature, the feature vector extracted from the first sample is encoded to obtain the encoded first sample feature, and the feature vector extracted from the second sample is encoded to obtain the encoded second sample feature.

In some embodiments, a language model can be trained by applying contrastive learning to the encoded features to highlight distinguishing features. In some embodiments, the loss can be determined by constructing a loss function with the following Equation (1):

$${L}_{contrastive} ( E ) = - {\sum }_{i = 1}^{N} log \frac{exp ( {E}_{i} \cdot {E}_{pos ( i )} / τ )}{{\sum }_{j = 1}^{N} exp ( {E}_{i} \cdot {E}_{j} / τ )} \qquad ( 1 )$$

where L_{contrastive}(E) is a loss associated with an encoded feature E, and Eᵢ is an encoded i-th data point and is the encoded object feature; Eₚₒₛ(i) is a positive example corresponding to the i-th data point and is the encoded first sample feature; Eⱼ is a j-th data point and is the encoded second sample feature; N is the number of data points, which may correspond to the number of samples in the sample library; and τ is a temperature parameter.

It should be understood that the smaller the L_{contrastive}(E) is, the closer the data point i is to the data point of the positive sample, and the further away the data point i is from the sample j, i.e., the more prominent the special feature is. In other words, the smaller the loss L_{contrastive}(E) is, the better, more accurate, and more correlated the language model is, and vice versa.

As shown in FIG. 4, at block 404, the loss is minimized to train the language model. For example, the loss L_{contrastive}(E) is minimized to obtain a language model with higher accuracy and relevance. At block 406, the object data is encoded using the trained language model to obtain enhanced features, and at block 408, the first text is generated based on the enhanced features. It should be understood that method 400 may also include, prior to block 406, preprocessing the object data to determine the features of the object data, where the features can be input into the language model for encoding.

With method 400, a language model can be trained and the first text can be generated using the trained language model, so the resulting first text can have higher accuracy and relevance to the object data.

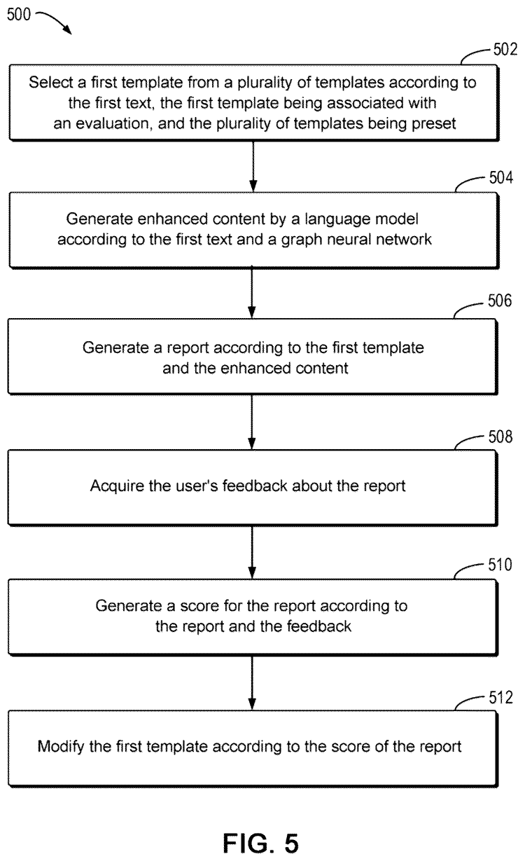

FIG. 5 is a flow chart of a method 500 for modifying a first template according to some embodiments of the present disclosure. At block 502, a first template is selected from a plurality of templates based on the first text, where the first template is associated with an evaluation of an object. For example, a template library can include various preset templates that are associated with different evaluations. For example, the template library can include positive evaluation templates, neutral evaluation templates, and negative evaluation templates.

At block 504, added content is generated by a language model according to the first text and a graph neural network. As mentioned above, the graph neural network is associated with relationships between a plurality of objects. In some embodiments, feature vectors can be extracted from the first text to obtain text tokens, features can be obtained from the graph neural network as graph tokens, and the text graph and the graph tokens are input into the language model to generate the enhanced content.

In some embodiments, nodes of the graph neural network can be used as graph tokens through node embedding. In some embodiments, node representations of a middle layer of the graph neural network can be obtained as graph tokens. In some embodiments, features can be extracted as graph tokens by aggregating neighborhood information using the graph neural network. It should be understood that these feature extraction approaches are provided as examples only, and that other methods can be used to extract features.

In some embodiments, the first text can be generated based on the user's negative evaluation of the object, the enhanced content is generated based on the first text and the graph neural network associated with a plurality of objects, and a negative evaluation template is selected from the template library based on the first text. In the above embodiment, in the first text, reasons why the user is not satisfied with the object or the user's perceived deficiencies of the object, as well as the causes and solutions of the deficiencies, can be analyzed, while in the enhanced text, whether a plurality of other objects also have the same deficiencies or have the risk of such deficiencies can be analyzed, along with corresponding solutions.

In some embodiments, a report can be generated based on using the enhanced content to complement the negative evaluation template. In the above embodiment, the report may reflect the user's perceived deficiencies of the object, the cause of the deficiencies, other objects at risk of having such deficiencies, other objects not at risk of such deficiencies, and a recommendation of relevant objects to the user according to the user's needs.

At block 506, a report is generated according to the first template and the enhanced content. In some embodiments, the first template can be input into the language model, and the language model generates the report based on the first template and the enhanced content. It should be understood that other models or neural networks can also be used to generate reports. The report generated according to the first template and the enhanced content utilizes the graph neural network, so that the relationships between a plurality of other objects can be taken into account. As a result, a more comprehensive analysis result can be obtained.

At block 508, the user's feedback about the report is obtained. For example, the user's feedback about the report can be obtained from a user feedback loop. For example, the user feedback loop is a continuous circulation process that includes collecting feedback information of the user, analyzing the feedback, making improvements or adjustments based on the feedback, and then providing an improved report to the user again, collecting feedback again, and so on to improve user satisfaction.

At block 510, a score of the report is generated according to the report and the feedback. In some embodiments, reinforcement learning can be applied to the user's feedback to improve the relevance and clarity of the report over time. For example, a reinforcement learning agent (RL agent) can be set to score the report based on the report and the feedback. Further, a reward function can be defined to measure a return or reward for taking a specific action in a specific state by the agent, and the agent can learn an optimal behavior strategy by maximizing the reward.

At block 512, the first template is modified according to the score of the report. In some embodiments, a threshold can be set, and when the score is less than the threshold, it is determined that the first template needs to be modified. In some embodiments, the agent may modify the first template to maximize the reward based on feedback from the environment (i.e., reward).

It should be understood that method 500 introduces a reinforcement learning mechanism that can dynamically modify templates based on the user's feedback, which can improve the quality of the templates over time, so that the templates are more accurate and relevant, thus improving the accuracy and efficiency of report generation.

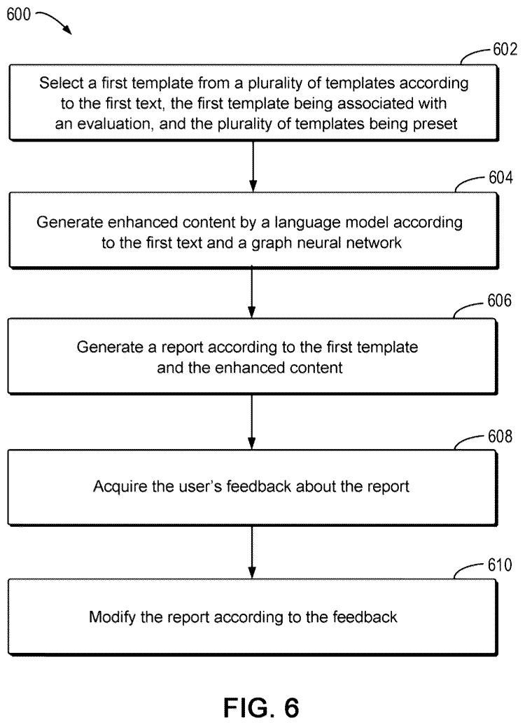

FIG. 6 is a flow chart of a method 600 for modifying a report according to some embodiments of the present disclosure. At block 602, a first template is selected from a plurality of templates based on the first text, where the first template is associated with an evaluation of an object. At block 604, added content is generated by a language model according to the first text and a graph neural network. At block 606, a report is generated according to the first template and the enhanced content. In some embodiments, the first template can be input into a language model, and the language model generates the report based on the first template and the enhanced content. It should be understood that blocks 602-608 are similar to blocks 502-508 in FIG. 5, so certain description thereof will not be repeated here.

As shown in FIG. 6, method 600 includes obtaining a user's feedback about the report at block 608, and modifying the report according to the feedback at block 610. In some embodiments, the report can be modified based on feedback through reinforcement learning. For example, a reward function can be defined to measure a return or reward received by an agent, and the agent modifies the report to maximize the reward.

It should be understood that with method 600, the report can be dynamically modified based on the user's feedback, so that the report can be made to meet the changing needs of the user, the report can be adapted to changing user preferences without extensive manual intervention, and the language model used to generate the report can become more accurate and efficient over time.

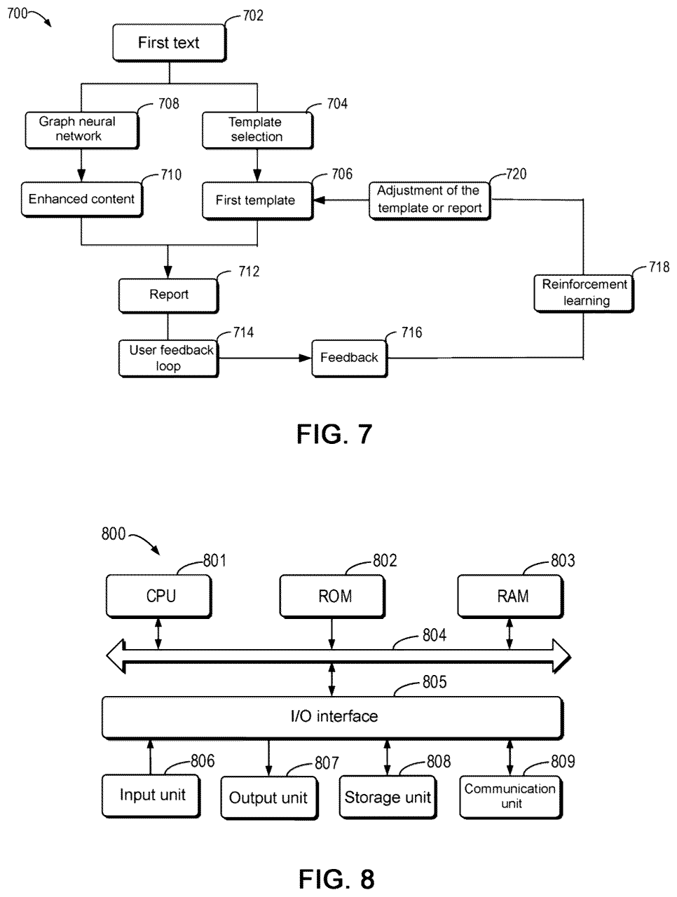

FIG. 7 is a schematic diagram of a process 700 for generating a report according to embodiments of the present disclosure. As shown in FIG. 7, template selection 704 is performed based on first text 702 generated by a language model according to object data to select a first template 706. In some embodiments, enhanced content 710 is generated by the language model according to the first text and a graph neural network 708. For example, features of the first text and features of the graph neural network 708 can be extracted to generate the enhanced content 710. For example, as mentioned above, the graph neural network can map complex relationships between a plurality of objects.

In some embodiments, the enhanced content 710 can be combined with the first template 706 by the language model to generate a report 712. For example, the enhanced content 710 is used to complement the first template 706 to generate the report 712. In some embodiments, feedback 716 can be obtained through a user feedback loop 714, and the template or report can be adjusted 720 according to the feedback 716. It should be understood that the above process performed by the language model is only exemplary and can also be performed through other models, neural networks, or algorithms.

In some embodiments, reinforcement learning 718 can be utilized to optimize the report 712 based on feedback 716. In some embodiments, reinforcement learning 718 is applied to the feedback 716, an agent is trained according to the first template 706 and the feedback 716, a reward value is computed, and the template or report is adjusted 720 according to the reward value.

In some embodiments, the agent can be trained in the reinforcement learning 718, and the reward value can be computed for the agent according to the feedback 716. The agent can update a strategy according to the reward value, modify the template or report, then generate feedback 716 based on the modified template or report through the user feedback loop 714, and compute the reward value again. The process is iterated constantly until a satisfactory reward value is obtained, in other words, until the agent achieves a satisfactory performance or convergence.

In some embodiments, feedback 716 may reflect only negative user feedback about the report 712. For example, feedback 716 is not generated when the user is satisfied with the report, and feedback 716 is generated when the user is dissatisfied with the report 712. In the above embodiment, a model for reinforcement learning 718 needs to be enabled only when feedback 716 is detected, thereby simplifying the process, reducing computational effort, and saving energy.

It should be understood that the above reinforcement learning 718 and the adjustment 720 of the template or report may be performed by the language model or other models, neural networks or algorithms, which is not limited in the present disclosure.

With process 700, a report on an object can be generated automatically by a machine without manual operation, which is more convenient and time-saving, and improves accuracy and efficiency. Since process 700 introduces a graph neural network that maps the relationships between a plurality of objects, a plurality of other objects can be taken into account from a report based on the object data of one object, so that a more comprehensive analysis result can be obtained. Further, process 700 includes a user feedback loop that continuously improves the accuracy and relevance of knowledge and reports. In addition, process 700 includes reinforcement learning that dynamically meets the needs of the user, and through continuous learning through a feedback loop, process 700 becomes more accurate and efficient over time.

FIG. 8 is a block diagram of an example device 800 that can be used to implement an embodiment of the present disclosure. As shown in the figure, the device 800 includes a computing unit 801, illustratively implemented as at least one central processing unit (CPU), which may execute various appropriate actions and processing according to computer program instructions stored in a read-only memory (ROM) 802 or computer program instructions loaded from a storage unit 808 onto a random access memory (RAM) 803. Various programs and data required for the operation of the device 800 may also be stored in the RAM 803. The computing unit 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The computing unit 801 may be various general-purpose and/or special-purpose processing components with processing and computing capabilities. Some examples of the computing unit 801 include, but are not limited to, the above-noted one or more CPUs, graphics processing units (GPUs), various specialized artificial intelligence (AI) computing chips, various computing units for running machine learning model algorithms, digital signal processors (DSPs), and any appropriate processors, controllers, microcontrollers, etc. The computing unit 801 performs the various methods and processes described above, such as methods 200-600 and process 700. For example, in some embodiments, methods 200-600 and process 700 may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded to the RAM 803 and executed by the computing unit 801, one or more steps of the methods 200-600 and the process 700 described above may be performed. Alternatively, in other embodiments, the computing unit 801 may be configured to implement methods 200-600 and process 700 in any other suitable manner (for example, by means of firmware).

The functions described herein may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

Program codes for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, this should not be construed as an indication that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method for generating a report, comprising:
acquiring object data associated with a user's evaluation of an object;
generating first text of the object by a language model according to the object data; and
generating the report according to the first text and a graph neural network, wherein the graph neural network is associated with a plurality of objects.

2. The method according to claim 1, wherein generating the first text of the object comprises:
preprocessing the object data to determine features of the object data;
encoding the features; and
generating the first text of the object according to the encoded features.

3. The method according to claim 2, wherein determining the features of the object data comprises:
filtering the object data;
normalizing the filtered object data; and
extracting the features of the object data according to the normalized filtered object data.

4. The method according to claim 1, wherein generating the report comprises:
selecting a first template from a plurality of templates according to the first text, the first template being associated with the evaluation, and the plurality of templates being preset;
generating added content by the language model according to the first text and the graph neural network; and
generating the report according to the first template and the added content.

5. The method according to claim 4, further comprising:
acquiring the user's feedback about the report;
generating a score of the report according to the report and the feedback; and
modifying the first template according to the score of the report.

6. The method according to claim 1, further comprising:
acquiring the user's feedback about the report; and
modifying the report according to the feedback.

7. The method according to claim 1, wherein the evaluation comprises a neutral evaluation, a positive evaluation, or a negative evaluation of the object.

8. The method according to claim 1, further comprising training the language model, wherein training the language model comprises:
determining a loss based on the first text, a first sample, and a second sample; and
minimizing the loss to train the language model;
wherein the first sample is generated according to the first text, and the second sample is acquired from a sample library; and
wherein the first sample is emotionally associated with the first text, and the second sample is not emotionally associated with the first text.

9. The method according to claim 8, wherein determining the loss comprises:
determining an encoded object feature according to the object data;
determining an encoded first sample feature according to the first sample;
determining an encoded second sample feature according to the second sample; and
determining the loss based on the encoded object feature, the encoded first sample feature, and the encoded second sample feature.

10. The method according to claim 1, wherein generating the first text of the object comprises:
preprocessing the object data to determine features of the object data;
encoding the features by a trained language model to obtain enhanced features; and
generating the first text according to the enhanced features.

11. An electronic device, comprising:
at least one processor; and
a memory coupled to the at least one processor and having instructions stored therein, wherein the instructions, when executed by the at least one processor, cause the electronic device to perform actions comprising:
acquiring object data associated with a user's evaluation of an object;
generating first text of the object by a language model according to the object data; and
generating a report according to the first text and a graph neural network, wherein the graph neural network is associated with a plurality of objects.

12. The electronic device according to claim 11, wherein generating the first text of the object comprises:
preprocessing the object data to determine features of the object data;
encoding the features; and
generating the first text of the object according to the encoded features.

13. The electronic device according to claim 12, wherein determining the features of the object data comprises:
filtering the object data;
normalizing the filtered object data; and
determining the features of the object data according to the normalized filtered object data.

14. The electronic device according to claim 11, wherein generating the report comprises:
selecting a first template from a plurality of templates according to the first text, the first template being associated with the evaluation, and the plurality of templates being preset;
generating added content by the language model according to the first text and the graph neural network; and
generating the report according to the first template and the added content.

15. The electronic device according to claim 14, wherein the actions further comprise:
acquiring the user's feedback about the report; and
generating a score of the report according to the report and the feedback; and
modifying the first template according to the score of the report.

16. The electronic device according to claim 11, wherein the actions further comprise:
acquiring the user's feedback about the report; and
modifying the report according to the feedback.

17. The electronic device according to claim 11, wherein the actions further comprise training the language model, wherein training the language model comprises:
determining a loss based on the first text, a first sample, and a second sample; and
minimizing the loss to train the language model;
wherein the first sample is generated according to the first text, and the second sample is acquired from a sample library; and
wherein the first sample is emotionally associated with the first text, and the second sample is not emotionally associated with the first text.

18. The electronic device according to claim 17, wherein determining the loss comprises:
determining an encoded object feature according to the object data;
determining an encoded first sample feature according to the first sample;
determining an encoded second sample feature according to the second sample; and
determining the loss based on the encoded object feature, the encoded first sample feature, and the encoded second sample feature.

19. The electronic device according to claim 11, wherein generating the first text of the object comprises:
preprocessing the object data to determine features of the object data;
encoding the features by a trained language model to obtain enhanced features; and
generating the first text according to the enhanced features.

20. A computer program product tangibly stored on a non-transitory computer-readable medium and comprising machine-executable instructions that, when executed by a machine, cause the machine to perform actions comprising:
acquiring object data associated with a user's evaluation of an object;
generating first text of the object according to the object data; and
generating a report according to the first text and a graph neural network, wherein the graph neural network is associated with a plurality of objects.
